(19) United States
(12) Patent Application Publication
(10) Pub. No.: US 2021/0187561 A1
(43) Pub. Date: Jun. 24, 2021

(54) CLEANING MECHANISM OF AUTOMATIC CLEANING MACHINE

(71) Applicant: Jason YAN, New Taipei City (TW)

(72) Inventor: Jason YAN, New Taipei City (TW)

(21) Appl. No.: 16/750,318

(22) Filed: Jan. 23, 2020

(30) Foreign Application Priority Data
Dec. 18, 2019 (TW) 108146381

(51) Int. Cl. B08B 3/04; B08B 1/00; B25J 9/00

(52) U.S. Cl. CPC B08B 3/041; B25J 9/0003; B08B 1/006

(57) ABSTRACT

The present invention provides an improved cleaning mechanism of automatic cleaning machine mainly comprising a base, a cleaning cloth and a plurality of protruding portions. The base is connected to the cleaning cloth, and the protruding portions are disposed on one side surface of the base facing the cleaning cloth, or on one side surface of the cleaning cloth facing the base, or simultaneously on the side surfaces of the base and the cleaning cloth facing each other, so that gaps are further provided between the base and the cleaning cloth to avoid a vacuum state formed by air being discharged by moisture.

### REFERENCE TO RELATED APPLICATIONS

The present application is based on, and claims priority from, Taiwan application number 108146381, filed 2019 Dec. 18, the disclosure of which is hereby incorporated by reference herein in its entirety.

### BACKGROUND OF THE INVENTION

### Field of Invention

The present invention is an improved cleaning mechanism of automatic cleaning machine, and more particularly is an improvement of a cleaning mechanism for a mopping robot.

### Related Art

With the popularization of automatic cleaning machines, and in order to achieve different cleaning purposes in the home environment, in addition to the original sweeping robots, in recent years, mopping robots have been gradually developed. The mopping robot is not the same as the sweeping robot. In order to achieve the mopping effect, it must be provided with a cleaning cloth and related water supply modules, and keep the cleaning cloth moist. However, when the connection base between the moist cleaning cloth and the robot is filled with moisture, the air between the two will be squeezed out and a vacuum state is formed, and this vacuum state will not only fail to provide a closer connection between the connection base and the cleaning cloth, but it adds more resistance, making the connection base unable to smoothly drive the cleaning cloth to rotate and clean, further slowing down or stagnating the moving speed of the mopping robot, resulting in consumption of power and reduction in cleaning efficiency.

In view of the various drawbacks derived from the above-mentioned conventional method, the inventor of the present invention has been eager to improve and innovate. After years of painstaking and diligent research, he finally developed an improved cleaning mechanism of automatic cleaning machine successfully.

### SUMMARY OF THE INVENTION

An improved cleaning mechanism of automatic cleaning machine of the present invention mainly comprises a base, a cleaning cloth and a plurality of protruding portions. The base is connected to the cleaning cloth, a sleeve-connect portion is provided at a middle of the base, wherein the protruding portions are solely provided on one side surface of the base facing the cleaning cloth, or solely provided on one side surface of the cleaning cloth facing the base, or simultaneously provided on opposite surfaces of the base and the cleaning cloth when the base and the cleaning cloth are connected, and gaps are made between the base and the cleaning cloth.

Wherein, the base is further provided with a plurality of seepage holes.

Wherein, the cleaning cloth is further provided with an outer sleeve portion on one side facing the base, one surface of the outer sleeve portion is surroundingly disposed with a plurality of opening-closing portions covering with the outer sleeve portion to form an accommodating portion, each of the opening-closing portions extends from a position adjacent to a periphery of the outer sleeve portion toward a middle of the outer sleeve portion, and the base is inserted into the accommodating portion from a gap adjacent to each of the opening-closing portions.

Wherein, the cleaning cloth is a water-absorbing material that can be replaced or washed.

Wherein, an end of each of the opening-closing portions extending toward the middle of the outer sleeve portion forms an insert portion, when the base is enclosed in the accommodating portion, the sleeve-connect portion at the middle of the base is capable of exposing outside and connecting to an automatic cleaning machine.

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 is a perspective view of a first embodiment of the present invention;

FIG. 2 is a cross-sectional view of the first embodiment of the present invention;

FIG. 3 is a perspective view of a second embodiment of the present invention;

FIG. 4 is a perspective view of a third embodiment of the present invention;

FIG. 5 is a schematic diagram of the present invention installed on an automatic cleaning machine;

FIG. 6 is a schematic diagram of the present invention installed on an automatic cleaning machine; and

FIG. 7 is a schematic diagram of the present invention installed on an automatic cleaning machine.

### DETAILED DESCRIPTION OF THE INVENTION

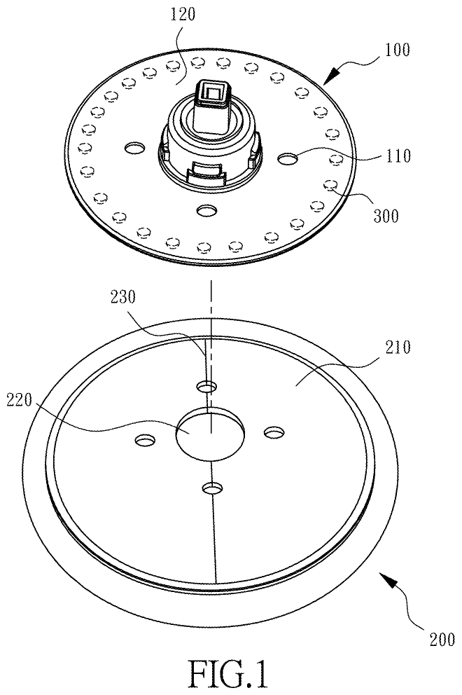

Please refer to FIG. 1, which is a perspective view of a first embodiment of an improved cleaning mechanism of automatic cleaning machine according to the present invention, which mainly includes a base 100, a cleaning cloth 200, and a plurality of protruding portions 300, wherein the base 100 and the cleaning cloth 200 are connected with each other, and the protruding portions 300 are provided between the base 100 and the cleaning cloth 200. As shown in the figure, the base 100 is provided with a plurality of seepage holes 110, and each of the seepage holes 110 is evenly distributed around a sleeve-connect portion 120, wherein the sleeve-connect portion 120 is used for connecting with an automatic cleaning machine. In addition, when the protruding portions 300 are evenly distributed on one side surface of the base 100 facing the cleaning cloth 200, and the base 100 and the cleaning cloth 200 are connected, gaps are formed between the base 100 and the cleaning cloth 200 to avoid a vacuum state formed by the air being discharged by the moisture.

In this embodiment, the cleaning cloth 200 is a water-absorbing material that can be replaced or cleaned, wherein, the cleaning cloth 200 is further provided with an outer sleeve portion 210 on one side facing the base 100, one surface of the outer sleeve portion 210 is surroundingly disposed with a plurality of opening-closing portions 230 covering with the outer sleeve portion 210 to form an accommodating portion 220, each of the opening-closing portions 230 extends from a position adjacent to a periphery of the outer sleeve portion 210 toward a middle of the outer sleeve portion 210, and the base 100 is inserted into the accommodating portion 220 from a gap adjacent to each of the opening-closing portions 230.

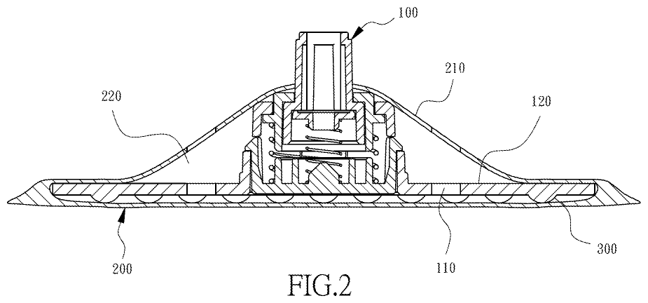

Please refer to FIG. 2, which is a cross-sectional view of the first embodiment of the present invention. After the base 100 is enclosed in the accommodating portion 220 of the cleaning cloth 200, and the protruding portions 300 evenly distributed on the side surface of the base 100 facing the cleaning cloth 200 abut an inner side of the cleaning cloth 200, the gaps are formed between the base 100 and the cleaning cloth 200 to prevent the base 100 and the cleaning cloth 200 from completely fitting with each other.

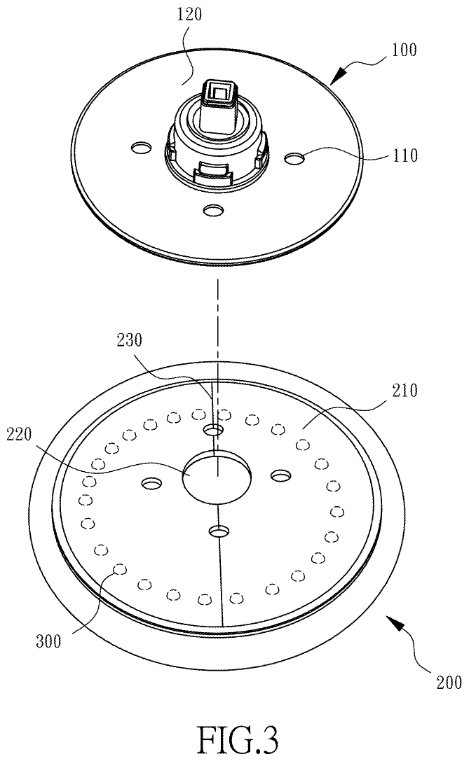

Please refer to FIG. 3, which is a perspective view of a second embodiment of the improved cleaning mechanism of automatic cleaning machine according to the present invention. Wherein the method for connecting the base 100 to the cleaning cloth 200 is the same as the first embodiment, and the difference lies in when the protruding portions 300 are evenly distributed on one side surface of the cleaning cloth 200 facing the base 100, and the base 100 and the cleaning cloth 200 are connected, the gaps are formed between the base 100 and the cleaning cloth 200 to avoid a vacuum state formed by the air being discharged by the moisture.

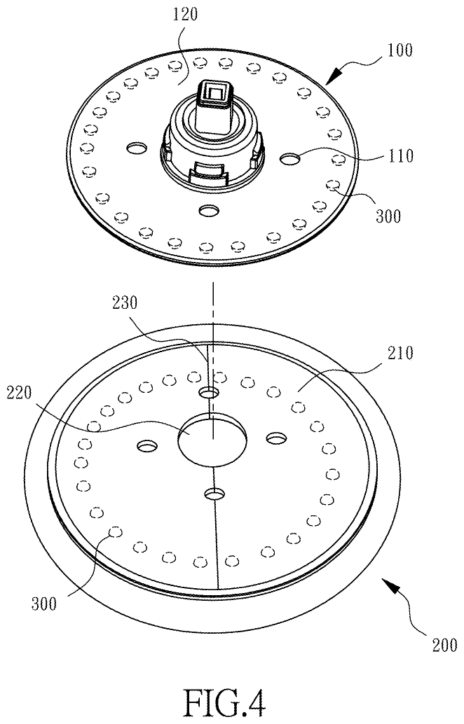

Please refer to FIG. 4, which is a perspective view of a third embodiment of the improved cleaning mechanism of automatic cleaning machine according to the present invention. Wherein the method for connecting the base 100 to the cleaning cloth 200 is the same as the first embodiment, and the difference lies in when the protruding portions 300 are evenly distributed on the side surfaces of the base 100 and the cleaning cloth 200 facing each other, and the base 100 and the cleaning cloth 200 are connected, the gaps are formed between the base 100 and the cleaning cloth 200 to avoid a vacuum state formed by the air being discharged by the moisture.

The above-mentioned first to third embodiments of the present invention are only ones of the connection methods of the base 100 and the cleaning cloth 200 of the present invention, but are not limited thereto. Any method for connecting the base 100 and the cleaning cloth 200 belongs to the scope protected by the present invention.

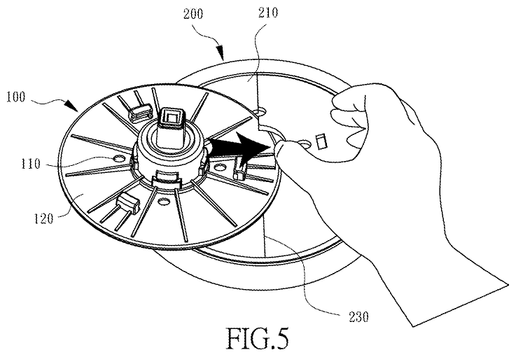

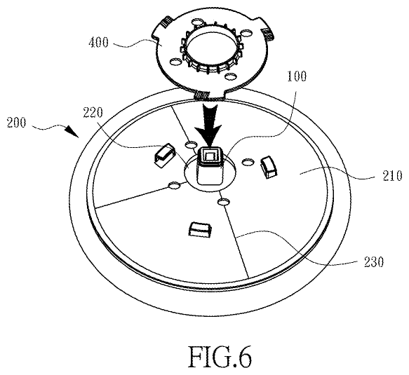

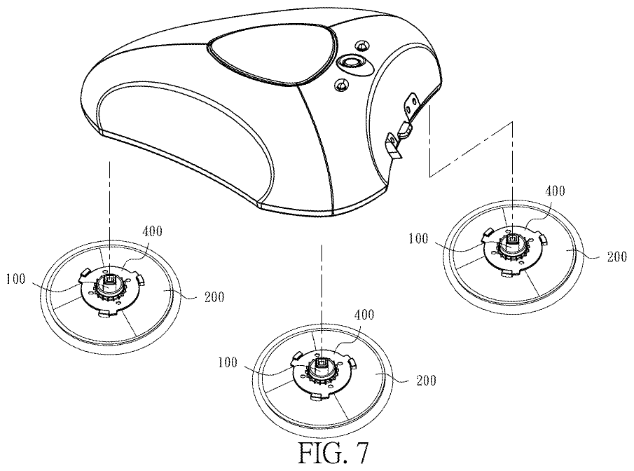

Please refer to FIG. 5 to FIG. 7, which are schematic diagrams of the present invention installed on an automatic cleaning machine. First, the base 100 is placed in the accommodating portion 220 from the opening-closing portions 230 on the cleaning cloth 200, and the sleeve-connect portion 120 at the middle of the base 100 is exposed outside of the outer sleeve portion 210. Then, a positioning seat 400 goes through the sleeve-connect portion 120 and is sleeved on the base 100. Finally, the sleeve-connect portion 120 is connected to a corresponding position of the automatic cleaning machine, and water or detergent supplied by the automatic cleaning machine flows into the cleaning cloth 200 through the seepage holes 110 to keep the cleaning cloth 200 moist.

The connection method of the present invention and the automatic cleaning machine can be implemented by the method disclosed in the Republic of China Patent No. 1587826. The above-mentioned are only ones of the connection methods of the present invention and the automatic cleaning machine, but are not limited thereto. Any method for connecting the base and the automatic cleaning machine belongs to the scope protected by the present invention.

In the prior art, because the water or detergent supplied by the automatic cleaning machine fills between the base and the cleaning cloth, the air between the base and the cleaning cloth is squeezed out to form a vacuum state. And this vacuum state not only cannot provide a closer connection between the connection base and the cleaning cloth, but it adds more resistance, making the connection base unable to smoothly drive the cleaning cloth to rotate and clean, further slowing down or stagnating the moving speed of the mopping robot, or the mopping robot will stop due to misjudging as encountering an obstacle, resulting in consumption of power and reduction in cleaning efficiency. The biggest difference between the present invention and the prior art lies in the connection between the base and the cleaning cloth, the protruding portions are disposed on the side surface of the base facing the cleaning cloth, or on the side surface of the cleaning cloth facing the base, or simultaneously on the side surfaces of the base and the cleaning cloth facing each other, so that the gaps are further provided between the base and the cleaning cloth to avoid a vacuum state formed by the air being discharged by the moisture.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An improved cleaning mechanism of automatic cleaning machine comprising:
a base, a sleeve-connect portion being provided at a middle of the base;
a cleaning cloth, the cleaning cloth being connected to the base; and
a plurality of protruding portions, each of the protruding portions being disposed on one side surface of the base facing the cleaning cloth, and gaps being made between the base and the cleaning cloth.

2. An improved cleaning mechanism of automatic cleaning machine comprising:
a base, a sleeve-connect portion being provided at a middle of the base;
a cleaning cloth, the cleaning cloth being connected to the base; and
a plurality of protruding portions, each of the protruding portions being disposed on one side surface of the cleaning cloth facing the base, and gaps being made between the base and the cleaning cloth.

3. An improved cleaning mechanism of automatic cleaning machine comprising:
a base, a sleeve-connect portion being provided at a middle of the base;
a cleaning cloth, the cleaning cloth being connected to the base; and
a plurality of protruding portions, each of the protruding portions being respectively disposed on one side surface of the base facing the cleaning cloth, and one side surface of the cleaning cloth facing the base, and gaps being made between the base and the cleaning cloth.

4. The improved cleaning mechanism of automatic cleaning machine as claimed in claim 1, wherein the base is further provided with a plurality of seepage holes.

5. The improved cleaning mechanism of automatic cleaning machine as claimed in claim 1, wherein the cleaning cloth is further provided with an outer sleeve portion on one side facing the base, one surface of the outer sleeve portion is surroundingly disposed with a plurality of opening-closing portions covering with the outer sleeve portion to form an accommodating portion, each of the opening-closing portions extends from a position adjacent to a periphery of the outer sleeve portion toward a middle of the outer sleeve portion, and the base is inserted into the accommodating portion from a gap adjacent to each of the opening-closing portions.

6. The improved cleaning mechanism of automatic cleaning machine as claimed in claim 1, wherein the cleaning cloth is a water-absorbing material that can be replaced or washed.

7. The improved cleaning mechanism of automatic cleaning machine as claimed in claim 1, wherein an end of each of the opening-closing portions extending toward the middle of the outer sleeve portion forms an insert portion.
